(19) United States
(12) Patent Application Publication
(10) Pub. No.: US 2025/0363759 A1
(43) Pub. Date: Nov. 27, 2025

(54) EFFECT IMAGE GENERATION METHOD AND APPARATUS, DEVICE, AND STORAGE MEDIUM

(71) Applicant: Beijing Zitiao Network Technology Co., Ltd., Beijing (CN)

(72) Inventors: Denggao WANG, Beijing (CN); Dongrui LI, Beijing (CN)

(21) Appl. No.: 18/875,100

(22) PCT Filed: Aug. 25, 2023
(86) PCT No.: PCT/CN2023/114934

§ 371 Date: Dec. 13, 2024

(30) Foreign Application Priority Data
Aug. 26, 2022 (CN) 202211035718.5

(51) Int. Cl. G06T 19/20; G06T 7/13; G06T 17/20

(52) U.S. Cl. CPC G06T 19/20; G06T 7/13; G06T 17/20; G06T 2219/2008; G06T 2219/2016

(57) ABSTRACT

An effect image generation method and apparatus, a device, and a storage medium. The effect image generation method includes: creating a plurality of initial graphic patches; performing edge detection on an original image to obtain an edge detection result; screening the plurality of initial graphic patches based on the edge detection result to obtain a target graphic patch; drawing set materials in the target graphic patch to obtain an initial effect image; and fusing the initial effect image with the original image to obtain a target effect image.

### CROSS-REFERENCE TO RELATED APPLICATION(S)

The present application claims priority to Chinese Patent Application No. 202211035718.5, filed with the China National Intellectual Property Administration on Aug. 26, 2022, which is incorporated herein by reference in its entirety.

### FIELD

The present disclosure relates to the field of image processing technologies, and for example, to an effect image generation method and apparatus, a device, and a storage medium.

### BACKGROUND

Image processing applications (APPs) have developed rapidly, entered users' lives, and gradually enriched users' spare time. Users can record life by using videos, photos, and the like, and can reprocess images by using effect technologies provided in image processing APPs, so that images are expressed in richer forms. In the related art, a generated effect image is not rich enough in content.

### SUMMARY

The present disclosure provides an effect image generation method and apparatus, a device, and a storage medium. Effect materials can be added to an edge of an object included in an image, so that content of the image is enriched, and display effect of the image is improved.

According to a first aspect, the present disclosure provides an effect image generation method, including:
creating a plurality of initial graphic patches;
performing edge detection on an original image to obtain an edge detection result, where the edge detection result is represented by an edge detection result;
screening the plurality of initial graphic patches based on the edge detection result to obtain a target graphic patch;
drawing set materials in the target graphic patch to obtain an initial effect image; and
fusing the initial effect image and the original image to obtain a target effect image.

According to a second aspect, the present disclosure further provides an effect image generation apparatus, including:
a graphic patch creation module configured to create a plurality of initial graphic patches;
an edge detection module configured to perform edge detection on an original image to obtain an edge detection result, where the edge detection result is represented by an edge detection result;
a target graphic patch obtaining module configured to screen the plurality of initial graphic patches based on the edge detection result to obtain a target graphic patch;
a set material drawing module configured to draw set materials in the target graphic patch to obtain an initial effect image; and
a target effect image obtaining module configured to fuse the initial effect image and the original image to obtain a target effect image.

According to a third aspect, the present disclosure further provides an electronic device. The electronic device includes:
one or more processors;
a storage apparatus configured to store one or more programs, where
the one or more programs, when executed by the one or more processors, cause the one or more processors to implement the effect image generation method described above.

According to a fourth aspect, the present disclosure further provides a storage medium including computer-executable instructions that, when executed by a computer processor, are used to perform the effect image generation method described above.

According to a fifth aspect, the present disclosure further provides a computer program product, including a computer program carried on a non-transitory computer-readable medium, where the computer program includes program code for performing the effect image generation method described above.

### BRIEF DESCRIPTION OF THE DRAWINGS

FIG. 1 is a schematic flowchart of an effect image generation method according to an embodiment of the present disclosure;

FIG. 2B is a diagram of an example of a plurality of graphic patches created according to an embodiment of the present disclosure;

FIG. 2B is a schematic diagram of a plurality of initial graphic patches according to an embodiment of the present disclosure;

FIG. 3A is a diagram of an example of an original image according to an embodiment of the present disclosure;

FIG. 3B is a schematic diagram of an edge detection diagram according to an embodiment of the present disclosure;

FIG. 3C is a diagram of an example of a screened target graphic patch according to an embodiment of the present disclosure;

FIG. 4A is a diagram of an example of a color noise diagram according to an embodiment of the present disclosure;

FIG. 4B is a diagram of an example of a target effect image according to an embodiment of the present disclosure;

FIG. 5 is a schematic structural diagram of an effect image generation apparatus according to an embodiment of the present disclosure; and

FIG. 6 is a schematic structural diagram of an electronic device according to an embodiment of the present disclosure.

### DETAILED DESCRIPTION OF EMBODIMENTS

Embodiments of the present disclosure are described below with reference to the accompanying drawings. Although some embodiments of the present disclosure are shown in the drawings, the present disclosure may be implemented in various forms, and these embodiments are provided for understanding the present disclosure. The drawings and embodiments of the present disclosure are used for illustrative purposes only.

A plurality of steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise.” The term “based on” is “at least partially based on.” The term “an embodiment” means “at least one embodiment.” The term “another embodiment” means “at least one another embodiment.” The term “some embodiments” means “at least some embodiments.” Related definitions of the other terms will be given in the description below.

Concepts such as “first” and “second” mentioned in the present disclosure are only used to distinguish different apparatuses, modules, or units, and are not used to limit an order or interdependence of functions performed by these apparatuses, modules, or units.

The modifiers “one” and “a plurality of” mentioned in the present disclosure are illustrative rather than restrictive, and persons skilled in the art should understand that unless the context clearly indicates otherwise, the modifiers should be understood as “one or more”.

Names of messages or information exchanged between a plurality of apparatuses in the implementation of the present disclosure are used for illustrative purposes only, and are not used to limit the scope of these messages or information.

Before using the technical solutions disclosed in the embodiments of the present disclosure, the types, usage scopes, usage scenarios, and the like of personal information involved in the present disclosure shall be informed to a user in an appropriate manner in accordance with relevant laws and regulations, and the user's authorization shall be obtained.

For example, when a user's active request is received, prompt information is sent to the user to explicitly prompt the user that an operation requested by the user will need to acquire and use the user's personal information. Therefore, the user can independently choose whether to provide personal information to software or hardware, such as an electronic device, an application, a server, or a storage medium, that performs an operation of the technical solution of the present disclosure according to the prompt information.

In an implementation, a manner of sending prompt information to the user in response to receiving the user's active request may be, for example, a pop-up window. The prompt information may be presented in the pop-up window in a text manner. In addition, the pop-up window may further carry a selection control for the user to select “agree” or “disagree” to provide personal information to the electronic device.

The above notification and user authorization obtaining process is merely illustrative, and does not constitute a limitation on an implementation of the present disclosure. Other manners that comply with relevant laws and regulations may also be applied to the implementation of the present disclosure.

Data (including the data itself, data acquisition, or data use) involved in the technical solution of the present disclosure shall comply with requirements of corresponding laws, regulations, and related regulations.

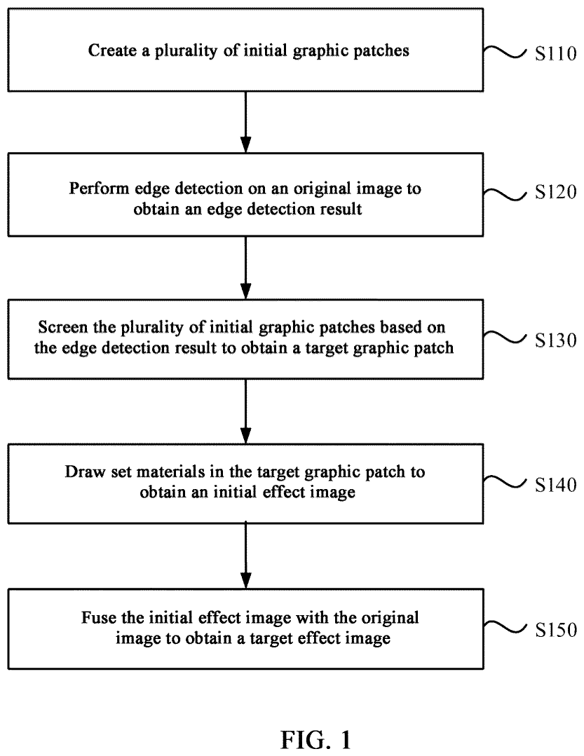

FIG. 1 is a schematic flowchart of an effect image generation method according to an embodiment of the present disclosure. The embodiment of the present disclosure is applicable to a case of generating an effect image. The method may be performed by an effect image generation apparatus. The apparatus may be implemented in a form of software and/or hardware, for example, implemented by an electronic device. The electronic device may be a mobile terminal, a personal computer (PC), a server, or the like.

As shown in FIG. 1, the method includes the following steps.

In S110, a plurality of initial graphic patches are created.

A graphic patch may be a patch in graphics. A graphic patch may be used to draw an image. A graphic patch is composed of a plurality of pixel points. Pixel values are filled into corresponding pixel points to draw an image. The plurality of initial graphic patches may be located at different positions in a layer and may have different sizes. Some areas of different initial graphic patches may overlap, or no area overlaps. In this embodiment, an initial graphic patch may be a rectangular graphic patch and is composed of two triangular primitives.

The plurality of initial graphic patches may be created in the following manner: creating an empty layer based on the original image, and performing mesh division on the empty layer to obtain a plurality of submeshes; and creating the plurality of initial graphic patches based on the plurality of submeshes.

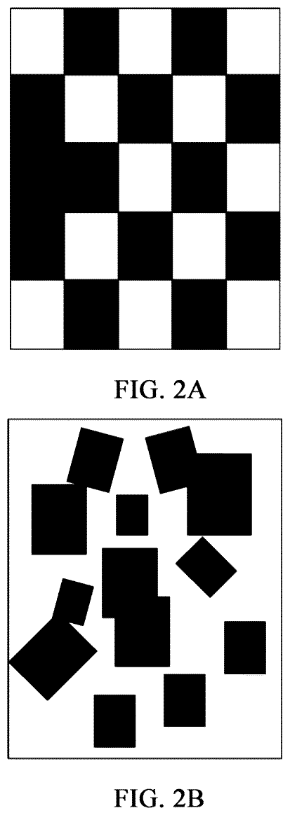

The size of the empty layer may be the same as the size of the original image, that is, an empty layer the same as the size of the original image is created. The plurality of initial graphic patches may be created based on the plurality of submeshes in the following manner: creating one graphic patch in each submesh, or randomly selecting a plurality of submeshes from the plurality of submeshes, all as candidate submeshes, and creating one graphic patch in each candidate submesh. A size of the graphic patch created in the mesh may be the same as or less than the size of the submesh. For example, the empty layer may be divided into M*N submeshes. Exemplarily, FIG. 2A is a diagram of an example of a plurality of graphic patches created according to an embodiment of the present disclosure. As shown in FIG. 2A, black areas in the figure are the created plurality of graphic patches. As shown in FIG. 2A, some submeshes are randomly selected from the plurality of divided submeshes, and graphic patches are created in the selected submeshes. In this embodiment, the plurality of graphic patches are created based on the plurality of divided submeshes, so that efficiency of creating the graphic patches can be improved.

The plurality of initial graphic patches may be created based on the plurality of submeshes in the following manner: selecting a set number of submeshes from the plurality of submeshes, all as candidate submeshes; creating graphic patches in the candidate submeshes; and performing at least one of the following operations on the created graphic patches to obtain the plurality of initial graphic patches: translation, rotation, and scaling.

The set number may be set by a user or determined according to a set proportion. If the set proportion is a % and a total number of submeshes is n, the set number is n*a %. The process of selecting the set number of submeshes from the plurality of submeshes may be: randomly selecting the set number of submeshes from the plurality of submeshes, all as the candidate submeshes.

The graphic patches may be created in the candidate submeshes in the following manner: obtaining vertex information of the candidate submeshes; and creating the graphic patches based on the vertex information.

The vertex information may be coordinate information of four vertices of the candidate submeshes. In this embodiment, the vertex information of the four vertices of the candidate submeshes is obtained, and the graphic patches are created by using the vertex information of the four vertices as vertex information of vertices of the graphic patches. The graphic patches are created based on the vertex information of the submeshes, so that speed of creating the graphic patches can be improved.

In this embodiment, the at least one operation of the translation, rotation, and scaling may be performed on the created graphic patches in the following manner: translation amounts, rotation amounts, and scaling amounts of different created graphic patches may be different. In this way, the initial graphic patches may have different sizes and different postures, or overlap. Exemplarily, FIG. 2B is a schematic diagram of a plurality of initial graphic patches according to an embodiment of the present disclosure. As shown in FIG. 2B, the plurality of initial graphic patches have different sizes, postures, and positions. In this embodiment, the at least one of the translation, rotation, and scaling is performed on the created graphic patches, so that diversity of effect images can be improved.

In S120, edge detection is performed on the original image to obtain an edge detection result.

The edge detection result may be represented by an edge point set or an edge detection diagram. The edge point set includes position information of each edge point in the original image. A pixel value of an edge point in the edge detection diagram may be represented by a first set value, and a pixel value of another pixel point is represented by a second set value. The first set value may be 1, and a pixel point of the first set value in an image is displayed as white. The second set value is 0, and a pixel point of the second set value in the image is displayed as black.

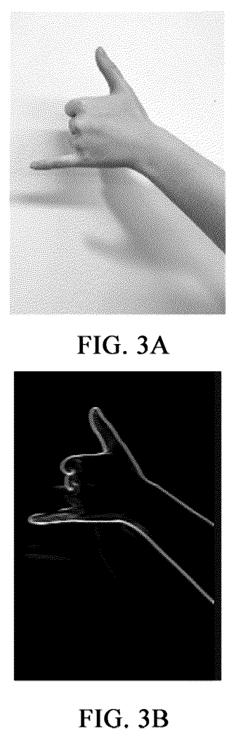

In this embodiment, edge detection may be performed on the original image by using a Sobel edge detection algorithm to obtain the edge detection result. Exemplarily, FIG. 3A is a diagram of an example of an original image according to an embodiment of the present disclosure, and FIG. 3B is a schematic diagram of an edge detection diagram according to an embodiment of the present disclosure. As shown in FIG. 3A, an object in the original image is a hand and a part of an arm. As shown in FIG. 3B, an edge detection result of the hand and the part of the arm is shown.

In S130, the plurality of initial graphic patches are screened based on the edge detection result to obtain a target graphic patch.

Screening the plurality of initial graphic patches based on the edge detection result may be to screen out initial graphic patches located at the edge to obtain the target graphic patch.

The plurality of initial graphic patches may be screened based on the edge detection result to obtain the target graphic patch in the following manner: determining a center point of each initial graphic patch; and determining an initial graphic patch whose center point falls into the edge detection result as the target graphic patch.

In this embodiment, an initial graphic patch may be a rectangular graphic patch and is composed of two triangular primitives. The center point of the initial graphic patch may be determined by determining a center point of a corresponding rectangle of the initial graphic patch. That the center point falls into the edge detection result may be that the center point of the initial graphic patch coincides with an edge point in the edge detection result, that is, position coordinates of the center point of the initial graphic patch are the same as position coordinates of the edge point in the edge detection result. In this embodiment, the initial graphic patch whose center point falls into the edge detection result is determined as the target graphic patch, so that the target graphic patch can be quickly determined.

The plurality of initial graphic patches may be screened based on the edge detection result to obtain the target graphic patch in the following manner: obtaining pixel points included in an initial graphic patch as graphic patch pixel points; and determining an initial graphic patch whose graphic patch pixel points fall into the edge detection result as the target graphic patch.

The pixel points included in the initial graphic patch may be obtained in the following manner: determining coordinate information of the pixel points included in the initial graphic patch based on vertex coordinates of the initial graphic patch. The method of determining an initial graphic patch whose graphic patch pixel points fall into the edge detection result as the target graphic patch may be: if one or more of the graphic patch pixel points of the initial graphic patch fall into the edge detection result, determining the initial graphic patch as the target graphic patch.

In this embodiment, a process of determining that the graphic patch pixel points fall into the edge detection result may be: traversing the graphic patch pixel points of the initial graphic patch, and determining whether position coordinates of a graphic patch pixel point that is traversed are the same as position coordinates of an edge point in the edge detection result. If the position coordinates of the graphic patch pixel point that is traversed are the same as the position coordinates of the edge point in the edge detection result, then the graphic patch pixel point that is traversed falls into the edge detection result, and continue to traverse the next graphic patch pixel point. In this embodiment, the initial graphic patch whose graphic patch pixel points fall into the edge detection result is determined as the target graphic patch, so that accuracy of determining the target graphic patch can be improved.

The method of determining the initial graphic patch whose graphic patch pixel points fall into the edge detection result as the target graphic patch may be: obtaining a number of graphic patch pixel points of the initial graphic patch that fall into the edge detection result; and determining an initial graphic patch whose obtained number of graphic patch pixel points exceeds a first set threshold as the target graphic patch.

The first set threshold may be a value set by the user. In this embodiment, the graphic patch pixel points of the initial graphic patch are traversed, and it is determined whether position coordinates of a graphic patch pixel point that is traversed are the same as position coordinates of an edge point in the edge detection result. If the position coordinates of the graphic patch pixel point that is traversed are the same as the position coordinates of the edge point in the edge detection result, then the graphic patch pixel point that is traversed falls into the edge detection result, and continue to traverse the next graphic patch pixel point, until the pixel points included in the current initial graphic patch are traversed. A number of graphic patch pixel points that fall into the edge detection result is counted, and the initial graphic patch whose number exceeds the first set threshold is determined as the target graphic patch. In this embodiment, the initial graphic patch whose number of graphic patch pixel points that fall into the edge detection result exceeds the first set threshold is determined as the target graphic patch, so that accuracy and reliability of the determined target graphic patch can be improved.

The method of determining the initial graphic patch whose graphic patch pixel points fall into the edge detection result as the target graphic patch may be: obtaining a proportion of a number of graphic patch pixel points of the initial graphic patch that fall into the edge detection result to a total number of graphic patch pixel points of the initial graphic patch; and determining an initial graphic patch whose obtained proportion exceeds a second set threshold as the target graphic patch.

The second set threshold may be set by the user. In this embodiment, the graphic patch pixel points of the initial graphic patch are traversed, and it is determined whether position coordinates of a graphic patch pixel point that is traversed are the same as position coordinates of an edge point in the edge detection result. If the position coordinates of the graphic patch pixel point that is traversed are the same as the position coordinates of the edge point in the edge detection result, then the graphic patch pixel point that is traversed falls into the edge detection result, and continue to traverse the next graphic patch pixel point, until the pixel points included in the current initial graphic patch are traversed. A number of graphic patch pixel points that fall into the edge detection result is counted, and a proportion of the number of graphic patch pixel points that fall into the edge detection result to a total number of pixel points included in the initial graphic patch is calculated. The initial graphic patch whose proportion exceeds the second set threshold is determined as the target graphic patch. In this embodiment, the initial graphic patch whose proportion of graphic patch pixel points that fall into the edge detection result to the total number of graphic patch pixel points exceeds the second set threshold is determined as the target graphic patch, so that accuracy and reliability of the determined target graphic patch can be improved.

Exemplarily, FIG. 3C is a diagram of an example of a screened target graphic patch according to an embodiment of the present disclosure. As shown in FIG. 3C, black frames in the figure are the screened target graphic patches.

In S140, set materials are drawn in the target graphic patch to obtain an initial effect image.

The set materials may be pre-designed material images, for example, a “star” image, a “love” image, or the like. A number of types of the set materials may be one or more. In this embodiment, the process of drawing the set materials in the target graphic patch may be: sampling pixel values from the set materials based on vertex information of the target graphic patch, and rendering a plurality of pixel points in the target graphic patch based on the sampled pixel values to generate the initial effect image.

The set materials may be drawn in the target graphic patch to obtain the initial effect image in the following manner: obtaining at least one set material; establishing a correspondence between the at least one set material and the plurality of target graphic patches; and drawing the at least one set material in a corresponding target graphic patch based on the correspondence to obtain the initial effect image.

The correspondence between the set materials and the target graphic patches may be a one-to-one, one-to-many, or many-to-many correspondence. In this embodiment, if there is one set material, the set material is sequentially drawn in the plurality of target graphic patches, that is, the correspondence between the set material and the plurality of target graphic patches is one-to-many. If there are a plurality of set materials, and a number of types of the set materials is less than a number of the target graphic patches, the plurality of set materials are randomly matched with the plurality of target graphic patches, and the plurality of set materials are sequentially drawn in corresponding target graphic patches based on a matching result, that is, the correspondence between the plurality of set materials and the plurality of target graphic patches is one-to-many. If the number of types of the set materials is greater than or equal to the number of the target graphic patches, then a one-to-one correspondence between the plurality of set materials and the plurality of target graphic patches is established, and the set materials are drawn in the corresponding target graphic patches based on the correspondence. In this embodiment, the at least one set material is drawn in the corresponding target graphic patch based on the correspondence, so that diversity of effect images can be improved.

The set materials may be drawn in the target graphic patch to obtain the initial effect image in the following manner: determining size information of the target graphic patch; obtaining, based on the size information, set materials corresponding to the target graphic patch; and drawing the set materials in the target graphic patch to obtain the initial effect image.

The size information of the target graphic patch may be a number of pixel points included in the target graphic patch, or an area occupied by the target graphic patch. In this embodiment, a correspondence between graphic patch size information and a set material category is established in advance. After the size information of the target graphic patch is obtained, a set material corresponding to the size information is determined based on the correspondence between the graphic patch size information and the set material category. Then, the set material is drawn in the corresponding target graphic patch to obtain the initial effect image. In this embodiment, the set materials corresponding to the target graphic patch are obtained based on the size information of the target graphic patch, so that not only can materials corresponding to each target graphic patch be accurately determined, but also diversity of effect images can be improved.

The set materials may be drawn in the target graphic patch to obtain the initial effect image in the following manner: obtaining a center point of the target graphic patch; obtaining a pixel value of a pixel point that corresponds to the center point in the original image; obtaining, based on the pixel value, set materials corresponding to the target graphic patch; and drawing the set materials in the target graphic patch to obtain the initial effect image.

In this embodiment, a correspondence between a pixel value range and a set material category is established in advance. Then, a range in which a pixel value of a pixel point that corresponds to the center point in the original image is located is determined. Set materials corresponding to the pixel value are determined based on the correspondence between the pixel value range and the set material category, and the set materials are drawn in the corresponding target graphic patch. In this embodiment, the set materials are determined based on the pixel value of the pixel point that corresponds to the center point of the target graphic patch in the original image, so that not only the materials corresponding to each target graphic patch can be accurately determined, but also diversity of effect images can be improved.

The set materials may be drawn in the target graphic patch to obtain the initial effect image in the following manner: obtaining position information of the target graphic patch; sampling color information from a set color noise diagram based on the position information; and drawing the set materials in the target graphic patch based on the color information to obtain the initial effect image.

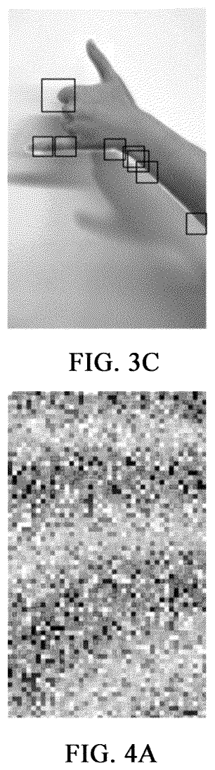

The position information of the target graphic patch may be represented by coordinates of a center point of the target graphic patch. In this embodiment, the color information is sampled from the set color noise diagram based on the position information of the target graphic patch, and the sampled color information is used as color information of the set materials drawn in the target graphic patch, so that the set materials are drawn in the target graphic patch based on the color information. Exemplarily, FIG. 4A is a diagram of an example of a color noise diagram according to an embodiment of the present disclosure. As shown in FIG. 4A, distribution of different colors is shown. In this embodiment, the color information of the set materials is sampled from the set color noise diagram, so that target graphic patches located at different positions display materials in different colors, thereby enriching display content of effect images.

The set materials may be drawn in the target graphic patch based on the color information to obtain the initial effect image in the following manner: performing set color mapping on the color information to obtain target color information; and drawing the set materials in the target graphic patch based on the target color information to obtain the initial effect image.

The process of performing the set color mapping on the color information may be: obtaining a pre-established color mapping relationship, and obtaining the target color information corresponding to the sampled color information based on the mapping relationship. In this embodiment, the set color mapping processing is performed on the color information, so that display content of effect images can be enriched.

In S150, the initial effect image is fused with the original image to obtain a target effect image.

In this embodiment, the initial effect image may be fused with the original image in the following manner: The initial effect image is fused with the original image in a color filtering mode to obtain the target effect image.

A principle of the color filtering mode may be that any color is fused with white to generate white, and any color is fused with black to remain unchanged. In this embodiment, the initial effect image is fused with the original image in the color filtering mode, so that fusion precision can be improved. Exemplarily, FIG. 4B is a diagram of an example of a target effect image according to an embodiment of the present disclosure. As shown in FIG. 4B, a “star” effect is generated at an edge of a hand and an arm in the figure.

In the technical solution of the embodiment of the present disclosure, a plurality of initial graphic patches are created; edge detection is performed on an original image to obtain an edge detection result, where the edge detection result is represented by an edge detection result; the plurality of initial graphic patches are screened based on the edge detection result to obtain a target graphic patch; set materials are drawn in the target graphic patch to obtain an initial effect image; and the initial effect image is fused with the original image to obtain a target effect image. In the effect image generation method provided in the embodiment of the present disclosure, the set materials are drawn in the graphic patch screened based on the edge detection result, so that effect materials can be added to an edge of an object included in an image, content of the image is enriched, and display effect of the image is improved.

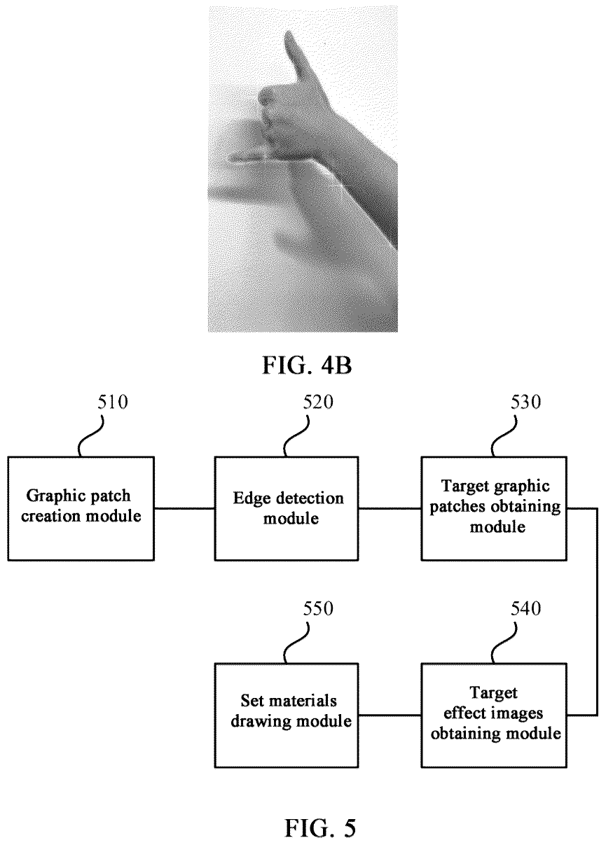

FIG. 5 is a schematic structural diagram of an effect image generation apparatus according to an embodiment of the present disclosure. As shown in FIG. 5, the apparatus includes:
a graphic patch creation module 510 configured to create a plurality of initial graphic patches; an edge detection module 520 configured to perform edge detection on an original image to obtain an edge detection result, where the edge detection result is represented by an edge detection result; a target graphic patch obtaining module 530 configured to screen the plurality of initial graphic patches based on the edge detection result to obtain a target graphic patch; a set material drawing module 540 configured to draw set materials in the target graphic patch to obtain an initial effect image; and a target effect image obtaining module 550 configured to fuse the initial effect image with the original image to obtain a target effect image.

The graphic patch creation module 510 is further configured to:
create an empty layer based on the original image; perform mesh division on the empty layer to obtain a plurality of submeshes; and create the plurality of initial graphic patches based on the plurality of submeshes.

The graphic patch creation module 510 is further configured to:
select a set number of submeshes from the plurality of submeshes, all as candidate submeshes; create graphic patches in the candidate submeshes; and perform at least one of the following operations on the created graphic patches to obtain the plurality of initial graphic patches: translation, rotation, and scaling.

The graphic patch creation module 510 is further configured to:
obtain vertex information of the candidate submeshes; and create the graphic patches based on the vertex information.

The target graphic patch obtaining module 530 is further configured to:
determine a center point of an initial graphic patch; and determine an initial graphic patch whose center point falls into the edge detection result as the target graphic patch.

The target graphic patch obtaining module 530 is further configured to:
obtain pixel points included in an initial graphic patch as graphic patch pixel points; and determine an initial graphic patch whose graphic patch pixel points fall into the edge detection result as the target graphic patch.

The target graphic patch obtaining module 530 is further configured to:
obtain a number of graphic patch pixel points of the initial graphic patch that fall into the edge detection result; and determine an initial graphic patch whose obtained number of graphic patch pixel points exceeds a first set threshold as the target graphic patch.

The target graphic patch obtaining module 530 is further configured to:
obtain a proportion of a number of graphic patch pixel points of the initial graphic patch that fall into the edge detection result to a total number of graphic patch pixel points of the initial graphic patch; and determine an initial graphic patch whose obtained proportion exceeds a second set threshold as the target graphic patch.

The set material drawing module 540:
obtains at least one set material; establishes a correspondence between the at least one set material

and the plurality of target graphic patches; and draws the at least one set material in a corresponding target graphic patch based on the correspondence to obtain the initial effect image.

The set material drawing module 540:
determines size information of the target graphic patch; obtains, based on the size information, set materials corresponding to the target graphic patch; and draws the set materials in the target graphic patch to obtain the initial effect image.

The set material drawing module 540:
obtains a center point of the target graphic patch; obtains a pixel value of a pixel point that corresponds to the center point in the original image; obtains, based on the pixel value, set materials corresponding to the target graphic patch; and draws the set materials in the target graphic patch to obtain the initial effect image.

The set material drawing module 540:
obtains position information of the target graphic patch; samples color information from a set color noise diagram based on the position information; and draws the set materials in the target graphic patch based on the color information to obtain the initial effect image.

The set material drawing module 540:
performs set color mapping on the color information to obtain target color information; and draws the set materials in the target graphic patch based on the target color information to obtain the initial effect image.

The target effect image obtaining module 550 is further configured to:
fuse the initial effect image with the original image in a color filtering mode to obtain the target effect image.

The effect image generation apparatus provided in the embodiment of the present disclosure may perform the effect image generation method provided in any embodiment of the present disclosure, and has corresponding functional modules and effect for performing the method.

The plurality of units and modules included in the foregoing apparatus are merely divided according to functional logic, but are not limited to the foregoing division, as long as corresponding functions can be implemented. In addition, names of the plurality of functional units are merely used to distinguish each other conveniently, and are not used to limit the scope of protection of the embodiments of the present disclosure.

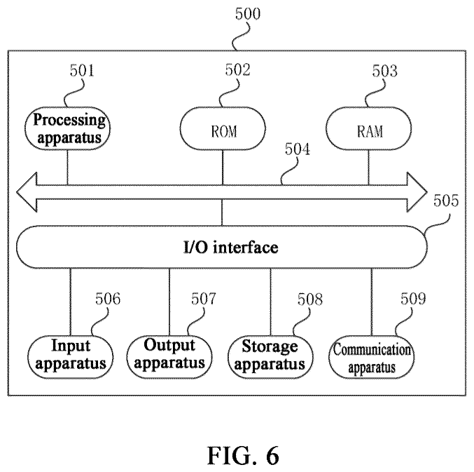

FIG. 6 is a schematic structural diagram of an electronic device according to an embodiment of the present disclosure. Referring to FIG. 6 below, FIG. 6 is a schematic structural diagram of an electronic device (for example, a terminal device or a server in FIG. 6) 500 suitable for implementing the embodiments of the present disclosure. A terminal device in this embodiment of the present disclosure may include mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a television (TV) and a desktop computer. The electronic device 500 shown in FIG. 6 is merely an example, and shall not impose any limitation on the function and scope of use of the embodiments of the present disclosure.

As shown in FIG. 6, the electronic device 500 may include a processing apparatus (for example, a central processor, a graphics processor, or the like) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 6 shows the electronic device 500 having various apparatuses, it is to be understood that it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above-mentioned functions defined in the method of the embodiment of the present disclosure are performed.

Names of messages or information exchanged between a plurality of apparatuses in the implementation of the present disclosure are used for illustrative purposes only, and are not used to limit the scope of these messages or information.

The electronic device provided in the embodiment of the present disclosure and the effect image generation method provided in the above embodiment belong to the same concept. For technical details that are not described in detail in this embodiment, reference may be made to the above embodiment, and this embodiment and the above embodiment have the same effect.

An embodiment of the present disclosure provides a computer storage medium having a computer program stored thereon, where when the program is executed by a processor, the effect image generation method provided in the foregoing embodiment is implemented.

The computer-readable medium described above in the present disclosure may be a computer-readable signal medium, a computer-readable storage medium, or any combination thereof. The computer-readable storage medium may be, for example, electric, magnetic, optical, electromagnetic, infrared, or semiconductor systems, apparatuses, or devices, or any combination thereof. Examples of the computer-readable storage medium may include: an electrical connection having one or more wires, a portable computer magnetic disk, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, where the computer-readable program code is carried. The propagated data signal may be in various forms, including an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained on the computer-readable medium may be transmitted by any suitable medium, including: electric wires, optical cables, radio frequency (RF), and the like, or any suitable combination thereof.

In some implementations, the client and the server may communicate by using any currently known or future-developed network protocol such as a hypertext transfer protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to: create a plurality of initial graphic patches; perform edge detection on an original image to obtain an edge detection result; screen the plurality of initial graphic patches based on the edge detection result to obtain a target graphic patch; draw set materials in the target graphic patch to obtain an initial effect image; and fuse the initial effect image with the original image to obtain a target effect image.

Computer program code for performing operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user through any type of network, including a local area network (LAN) or a wide area network (WAN), or may be connected to an external computer (for example, connected through the Internet by using an Internet service provider).

The flowcharts and block diagrams in the accompanying drawings illustrate a possible system architecture, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession may actually be executed substantially in parallel, or they may sometimes be executed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software, or may be implemented by hardware. The name of a unit does not constitute a limitation on the unit in some cases. For example, a first obtaining unit may also be described as “a unit for obtaining at least two Internet protocol addresses”.

The functions described hereinabove in the present disclosure may be performed at least partially by one or more hardware logic components. For example, as a non-limiting example, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or any suitable combination thereof. Examples of the machine-readable storage medium may include electrical connections based on one or more wires, a portable computer disk, a hard disk, a RAM, a ROM, an EPROM or flash memory, an optical fiber, a CD-ROM, an optical storage device, a magnetic storage device, or any suitable combination thereof.

According to one or more embodiments of the present disclosure, an effect image generation method is provided, including:
creating a plurality of initial graphic patches;
performing edge detection on an original image to obtain an edge detection result;
screening the plurality of initial graphic patches based on the edge detection result to obtain a target graphic patch;
drawing set materials in the target graphic patch to obtain an initial effect image; and
fusing the initial effect image with the original image to obtain a target effect image.

The creating a plurality of initial graphic patches includes:
creating an empty layer based on the original image;
performing mesh division on the empty layer to obtain a plurality of submeshes; and
creating the plurality of initial graphic patches based on the plurality of submeshes.

The creating the plurality of initial graphic patches based on the plurality of submeshes includes:
selecting a set number of submeshes from the plurality of submeshes, all as candidate submeshes;
creating graphic patches in the candidate submeshes; and
performing at least one of the following operations on the created graphic patches to obtain the plurality of initial graphic patches: translation, rotation, and scaling.

The creating graphic patches in the candidate submeshes includes:
obtaining vertex information of the candidate submeshes; and
creating the graphic patches based on the vertex information.

The screening the plurality of initial graphic patches based on the edge detection result to obtain a target graphic patch includes:
determining a center point of the initial graphic patch; and
determining an initial graphic patch whose center point falls into the edge detection result as the target graphic patch.

The screening the plurality of initial graphic patches based on the edge detection result to obtain a target graphic patch includes:
obtaining pixel points included in an initial graphic patch as graphic patch pixel points; and
determining an initial graphic patch whose graphic patch pixel points fall into the edge detection result as the target graphic patch.

The determining an initial graphic patch whose graphic patch pixel points fall into the edge detection result as the target graphic patch includes:
obtaining a number of graphic patch pixel points of the initial graphic patch that fall into the edge detection result; and
determining an initial graphic patch whose obtained number of graphic patch pixel points exceeds a first set threshold as the target graphic patch.

The determining an initial graphic patch whose graphic patch pixel points fall into the edge detection result as the target graphic patch includes:
obtaining a proportion of a number of graphic patch pixel points of the initial graphic patch that fall into the edge detection result to a total number of graphic patch pixel points of the initial graphic patch; and
determining an initial graphic patch whose obtained proportion exceeds a second set threshold as the target graphic patch.

The drawing set materials in the target graphic patch to obtain an initial effect image includes:
obtaining at least one set material;
establishing a correspondence between the at least one set material and the plurality of target graphic patches; and
drawing the at least one set material in a corresponding target graphic patch based on the correspondence to obtain the initial effect image.

The drawing set materials in the target graphic patch to obtain an initial effect image includes:
determining size information of the target graphic patch;
obtaining, based on the size information, set materials corresponding to the target graphic patch; and
drawing the set materials in the target graphic patch to obtain the initial effect image.

The drawing set materials in the target graphic patch to obtain an initial effect image includes:
obtaining a center point of the target graphic patch;
obtaining a pixel value of a pixel point that corresponds to the center point in the original image;
obtaining, based on the pixel value, set materials corresponding to the target graphic patch; and
drawing the set materials in the target graphic patch to obtain the initial effect image.

The drawing set materials in the target graphic patch to obtain an initial effect image includes:
obtaining position information of the target graphic patch;
sampling color information from a set color noise diagram based on the position information; and
drawing the set materials in the target graphic patch based on the color information to obtain the initial effect image.

The drawing the set materials in the target graphic patch based on the color information to obtain the initial effect image includes:
performing set color mapping processing on the color information to obtain target color information; and
drawing the set materials in the target graphic patch based on the target color information to obtain

the initial effect image.

The fusing the initial effect image with the original image to obtain a target effect image includes:
fusing the initial effect image with the original image in a color filtering mode to obtain the target effect image.

Further, although a plurality of operations are depicted in a specific order, it should be understood as requiring these operations to be performed in the specific order shown or in a sequential order. Under certain circumstances, multitasking and parallel processing may be advantageous. Similarly, although several implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

1. An effect image generation method, comprising:
creating a plurality of initial graphic patches;
performing edge detection on an original image to obtain an edge detection result;
screening the plurality of initial graphic patches based on the edge detection result to obtain a target graphic patch;
drawing a set material in the target graphic patch to obtain an initial effect image; and
fusing the initial effect image with the original image to obtain a target effect image.

2. The method according to claim 1, wherein the creating a plurality of initial graphic patches comprises:
creating an empty layer based on the original image;
performing mesh division on the empty layer to obtain a plurality of submeshes; and
creating the plurality of initial graphic patches based on the plurality of submeshes.

3. The method according to claim 2, wherein the creating the plurality of initial graphic patches based on the plurality of submeshes comprises:
selecting a set number of submeshes from the plurality of submeshes as candidate submeshes;
creating a graphic patch in the candidate submeshes; and
performing at least one of the following operations on the created graphic patch to obtain the plurality of initial graphic patches: translation, rotation, and scaling.

4. The method according to claim 3, wherein the creating a graphic patch in the candidate submeshes comprises:
obtaining vertex information of the candidate submeshes; and
creating the graphic patch based on the vertex information.

5. The method according to claim 1, wherein the screening the plurality of initial graphic patches based on the edge detection result to obtain a target graphic patch comprises:
determining a center point of the initial graphic patches; and
determining an initial graphic patch whose center point falls into the edge detection result as the target graphic patch.

6. The method according to claim 1, wherein the screening the plurality of initial graphic patches based on the edge detection result to obtain a target graphic patch comprises:
obtaining pixel points included in the initial graphic patches as graphic patch pixel points; and
determining an initial graphic patch whose graphic patch pixel point falls into the edge detection result as the target graphic patch.

7. The method according to claim 6, wherein the determining an initial graphic patch whose graphic patch pixel point falls into the edge detection result as the target graphic patch comprises:
obtaining a number of graphic patch pixel points of the initial graphic patch that fall into the edge detection result; and
determining an initial graphic patch whose obtained number of graphic patch pixel points exceeds a first set threshold as the target graphic patch.

8. The method according to claim 6, wherein the determining an initial graphic patch whose graphic patch pixel point falls into the edge detection result as the target graphic patch comprises:
obtaining a proportion of a number of graphic patch pixel points of the initial graphic patch that fall into the edge detection result to a total number of graphic patch pixel points of the initial graphic patch; and
determining an initial graphic patch whose obtained proportion exceeds a second set threshold as the target graphic patch.

9. The method according to claim 1, wherein the drawing a set material in the target graphic patch to obtain an initial effect image comprises:
obtaining at least one set material;
establishing a correspondence between the at least one set material and the plurality of target graphic patches; and
drawing the at least one set material in a corresponding target graphic patch based on the correspondence to obtain the initial effect image.

10. The method according to claim 1, wherein the drawing a set material in the target graphic patch to obtain an initial effect image comprises:
determining size information of the target graphic patch;
obtaining, based on the size information, a set material corresponding to the target graphic patch; and
drawing the set material in the target graphic patch to obtain the initial effect image.

11. The method according to claim 1, wherein the drawing set a material in the target graphic patch to obtain an initial effect image comprises:
obtaining a center point of the target graphic patch;
obtaining a pixel value of a pixel point that corresponds to the center point in the original image;
obtaining, based on the pixel value, a set material corresponding to the target graphic patch; and
drawing the set material in the target graphic patch to obtain the initial effect image.

12. The method according to claim 1, wherein the drawing a set material in the target graphic patch to obtain an initial effect image comprises:
obtaining position information of the target graphic patch;
sampling color information from a set color noise diagram based on the position information; and
drawing the set material in the target graphic patch based on the color information to obtain the initial effect image.

13. The method according to claim 12, wherein the drawing the set material in the target graphic patch based on the color information to obtain the initial effect image comprises:
performing a set color mapping processing on the color information to obtain target color information; and
drawing the set material in the target graphic patch based on the target color information to obtain the initial effect image.

14. The method according to claim 1, wherein the fusing the initial effect image with the original image to obtain a target effect image comprises:
fusing the initial effect image with the original image in a color filtering mode to obtain the target effect image.

15. (canceled)

16. An electronic device, comprising:
at least one processor; and
a storage apparatus configured to store at least one program;
the at least one program, when executed by the at least one processor, causes the at least one processor to:
create a plurality of initial graphic patches;
perform edge detection on an original image to obtain an edge detection result;
screen the plurality of initial graphic patches based on the edge detection result to obtain a target graphic patch;
draw a set material in the target graphic patch to obtain an initial effect image; and
fuse the initial effect image with the original image to obtain a target effect image.

17. (canceled)

18. A computer program product, comprising a computer program carried on a non-transitory computer-readable medium, wherein the computer program contains program code to:
create a plurality of initial graphic patches;
perform edge detection on an original image to obtain an edge detection result;
screen the plurality of initial graphic patches based on the edge detection result to obtain a target graphic patch;
draw a set material in the target graphic patch to obtain an initial effect image; and
fuse the initial effect image with the original image to obtain a target effect image.

19. The electronic device of claim 16, wherein the at least one program causing the at least one processor to create a plurality of initial graphic patches comprises instructions to:
create an empty layer based on the original image;
perform mesh division on the empty layer to obtain a plurality of submeshes; and
create the plurality of initial graphic patches based on the plurality of submeshes.

20. The electronic device of claim 17, wherein the at least one program causing the at least one processor to create the plurality of initial graphic patches based on the plurality of submeshes comprises instructions to:
select a set number of submeshes from the plurality of submeshes as candidate submeshes;
create a graphic patch in the candidate submeshes; and
perform at least one of the following operations on the created graphic patches to obtain the plurality of initial graphic patches: translation, rotation, and scaling.

21. The electronic device of claim 18, wherein the at least one program causing the at least one processor to create a graphic patch in the candidate submeshes comprises instructions to:
obtain vertex information of the candidate submeshes; and
create the graphic patch based on the vertex information.

22. The electronic device of claim 16, wherein the at least one program causing the at least one processor to screen the plurality of initial graphic patches based on the edge detection result to obtain a target graphic patch comprises instructions to:
determine a center point of the initial graphic patches; and
determine an initial graphic patch whose center point falls into the edge detection result as the target graphic patch.
